(19) United States
(12) Patent Application Publication
(10) Pub. No.: US 2026/0012739 A1
(43) Pub. Date: Jan. 8, 2026

(54) TRACKING A SOUND MOVING THROUGH AN ENVIRONMENT TO NOTIFY AFFECTED DEVICES

(71) Applicant: INTERNATIONAL BUSINESS MACHINES CORPORATION, ARMONK, NY (US)

(72) Inventors: Mark James Lawrence, Eastleigh (GB); SAMIR NASSER, Durham, NC (US); NEIL DELIMA, Scarborough (CA); Unwin Cynthia Susan, Innisfil (CA)

(21) Appl. No.: 18/765,603

(22) Filed: Jul. 8, 2024

(51) Int. Cl. H04R 29/00

(52) U.S. Cl. CPC H04R 29/00

(57) ABSTRACT

Provided are a computer program product, system, and method for tracking a sound moving through an environment to notify affected devices. Sound monitor position information is maintained on a plurality of sound monitors distributed at physical locations and connecting via a network. The sound monitor position information indicates, for the sound monitors receiving sounds, next sound monitors to next receive the sounds received at the sound monitors. A sound is detected at a receiving sound monitor. A determination is made, from the sound monitor position information, a next sound monitor to receive the sound after the receiving sound monitor. A determination is made of a device connected to the next sound monitor. A notification is sent to the device over the network that a sound is soon to arrive, wherein the notification causes the device to take mitigation to reduce impact of the sound at the device.

### BACKGROUND OF THE INVENTION

### 1. Field of the Invention

The present invention relates to a computer program product, system, and method for tracking a sound moving through an environment to notify affected devices.

### 2. Description of the Related Art

Current noise reduction technologies seek to filter out and reduce background noise pollution. Noise-cancelling technology uses microphones and speakers to reduce or eliminate unwanted noise by generating a sound wave that cancels out ambient background noise. This phenomenon creates anti-noise, which is then compressed with a listener's choice of audio in real time.

### SUMMARY

Provided are a computer program product, system, and method for tracking a sound moving through an environment to notify affected devices. Sound monitor position information is maintained on a plurality of sound monitors distributed at physical locations and connecting via a network. The sound monitor position information indicates, for the sound monitors receiving sounds, next sound monitors to next receive the sounds received at the sound monitors. A sound is detected at a receiving sound monitor comprising one of the sound monitors. A determination is made, from the sound monitor position information, a next sound monitor of the sound monitors to receive the sound after the receiving sound monitor. A determination is made of a device connected to the next sound monitor. A notification is sent to the device over the network that a sound is soon to arrive, wherein the notification causes the device to take mitigation to reduce impact of the sound at the device.

### BRIEF DESCRIPTION OF THE DRAWINGS

FIG. 1 illustrates an embodiment of an environment in which sound monitors are deployed to track a sound propagating in the environment.

FIG. 2 illustrates an embodiment of a manager sound monitor.

FIG. 3 illustrates an embodiment of a satellite sound monitor.

FIG. 4 illustrates an embodiment of a sound monitor position record.

FIG. 5 illustrates an embodiment of a connected device record for devices connected to the sound monitors

FIG. 6 illustrates an embodiment of operations performed by a sound monitor position service to determine next sound monitors to receive sounds received at the sound monitors to indicate in sound monitor position records.

FIG. 7 illustrates an embodiment of operations to train the sound tracking service using the sound monitor position records

FIG. 8 illustrates an embodiment of operations to create connected device records on devices connected to the sound monitors.

FIG. 9 illustrates an embodiment of operations performed by a sound tracking service to track a sound at sound monitors in the environment to notify a device of an incoming sound.

FIG. 10 illustrates a computing environment in which the components of FIGS. 1, 2, and 3 may be implemented.

### DETAILED DESCRIPTION

“Unexpected” background noises or loud unexpected sounds from an unmuted participant in a video/phone conference can cause an unpleasant experience for all participants and embarrassment to the participant that introduced the unexpected sound. Current noise reduction technologies are designed to reduce continual background noise pollution and are ineffective in limiting the impact of a one-off, loud, unexpected noise interruption.

Described embodiments address the problems of current noise reduction technologies by utilizing an array of sound monitors, which may be implemented in smart speakers. The array of sound monitors are deployed throughout an environment and can track the progress of an “unexpected” large sound source as it propagates through the environment. While the sound propagates through the environment, a determination is made of sound monitors that are next in line to receive the propagating “unexpected” sound after the sound monitor that just received the sound. The next sound monitor in line to receive the sound may send notifications to nearby devices of the incoming sound to allow the devices to mitigate the impact of such sound, such as muting microphones and speakers or moving to a quiet location.

As the “unexpected” sound travels towards the location of the computer running the video/phone conference, the computer will receive a notification from a nearby sound monitor next in line to receive the sound. The video/phone conference software may include a program to respond to the notification by muting the microphone before the sound is broadcasted into the video/phone conference.

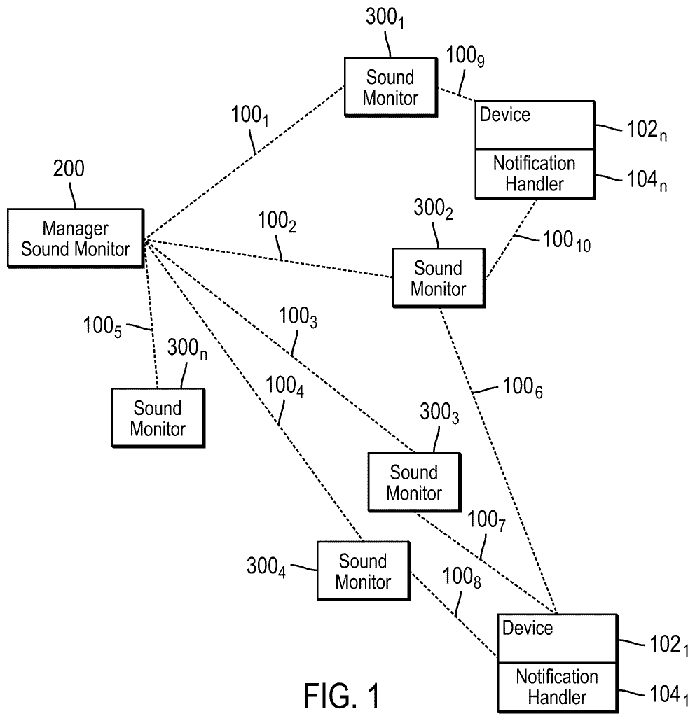

FIG. 1 illustrates an embodiment of an arrangement of a manager sound monitor 200 and satellite sound monitors 300₁, 300₂ . . . 300ₙ in a location or environment, such as a single or multi-story residence, office building, floor of building, warehouse, building complex, etc. The manager sound monitor 200 receives messages from the sound monitors 300₁ . . . 300n over wireless communication links 100₁, 100₂ . . . 100ₙ. Sound monitors 300ᵢ may be in communication with other devices, such as devices 102₁ . . . 102ₙ communicating with sound monitors 300₃, 300₄ over wireless communication links 100₆, 100₇, 100₈, 100₉, 100₁₀. The devices 102ᵢ include a notification handler 104ⱼ to handle notifications from the manager sound monitor 200 about upcoming noises so the devices 102ᵢ can take action to avoid the effect of the upcoming noise, such as mute a microphone, pause a recording, mute or muffle speakers, etc. The sound monitors 200, 300ᵢ may include a speaker, and may comprise smart speakers.

The wireless communication links 100ᵢ may form a mesh network. The wireless communication links 100ᵢ may utilize a wireless technology such as Bluetooth®, etc. The devices 102ᵢ connected to the sound monitors 300ᵢ may comprise personal computing devices, smartphone, laptops, tablets, etc. at which a user is working. The manager 200_{M} may connect with the sound monitors 100ᵢ using Bluetooth® or other communication protocol that may form a mesh network among the sound monitors 200, 300ᵢ, and devices 102ᵢ. (Bluetooth is a registered trademark of the Bluetooth Special Interest Group (SIG) throughout the world)

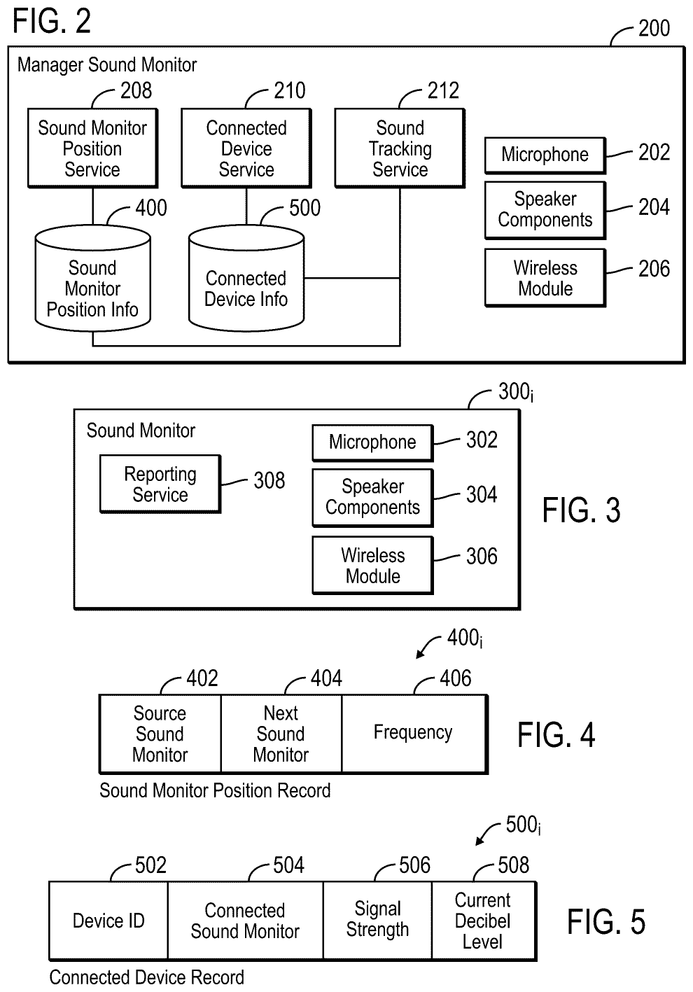

FIG. 2 illustrates an embodiment of a manager sound monitor 200 including a microphone 202 to detect sounds, optional sound monitor components 204 to produce sound, and a wireless module 206 to communicate wirelessly with the satellite sound monitors 300ᵢ and devices 102ᵢ. The manager sound monitor 200 includes a sound monitor position service 208 to determine sound monitors 300ᵢ likely to next receive a sound following the current sound monitor 300ⱼ detecting the sound. Information on next sound monitors to receive sounds following the current sound monitors is maintained in records in sound monitor position information 400. As shown in FIG. 4, each sound monitor position record 400ᵢ indicates a source sound monitor 402 detecting a sound; a next sound monitor 404 comprising a first sound monitor to detect the sound after being detected by the source sound monitor 402; and a frequency 406 indicating a number of times the next sound monitor 404 was determined to be the first sound monitor detecting a sound after detected by the source sound monitor 402. The sound monitor position service 208 generates the sound monitor position records 400ᵢ,

The manager sound monitor 200 includes a connected device service 210 to receive information from the satellite sound monitors 300ᵢ on devices 102ᵢ that are connected to the sound monitors 300ᵢ and generate connected device records 500ᵢ to store in the connected device information 500. A shown in FIG. 5, a connected device record 500ᵢ includes a device identifier (ID) 502 of a device 102ᵢ; a connected sound monitor 504 that is connected with the device 502; a signal strength 506 of the wireless connection between the device 502 and the connected sound monitor 504, which may be expressed as a Received Signal Strength Indicator (RSSI); and a current decibel level 508 at the connected sound monitor 504. In certain embodiments, the signal strength 506 is expressed as RSSI value. Alternatively, the RSSI may be expressed as a negative dBm value relating to the signal strength or power present in a received signal. The higher the number, the stronger the signal. RSSI measures how well the device 502 can receive a signal from the connected sound monitor 504. In alternative embodiments, the device 502 and connected sound monitor 504 may be connected over a wired connection.

The manager sound monitor 200 further includes a sound tracking service 212 that upon receiving a message from a sound monitor 300ᵢ of detection of a sound that exceeds a certain noise threshold, tracks the movement of the sound through the sound monitors 300ᵢ. The sound tracking service 212 may alert a device 102ᵢ close to a sound monitor that is likely soon to receive the impending sound. Upon notification, the device 102ᵢ notification handler 104ᵢ may take protective action, such as mute a microphone at the device 102ᵢ or mute a headphone at the device 102ᵢ. In this way, a user at the device 102ᵢ is spared the disruptive effect of an incoming noise exceeding a disturbance threshold. For instance, if the user of the device 102ᵢ is participating in a video/phone conference, the notification handler 104ᵢ at the device 102ᵢ may mute a microphone at the device 102ᵢ so participants in the video conference do not hear the sound.

FIG. 3 illustrates an embodiment of a sound monitor 300ᵢ including a microphone 302, optional speaker components 304, and a wireless module 306 to communicate with the manager sound monitor 200 and connected devices 102ᵢ. The sound monitor 300ᵢ further includes a reporting service 308 to report to the manager sound monitor 200 a detected noise above a noise threshold and information on connected devices 102ᵢ.

In the embodiment of FIG. 1, there is shown just one manager sound monitor 200. However, in certain environments encompassing a larger space, such as a large multi-floor building, a warehouse, a large complex of buildings, or other large space, there may be multiple edge manager sound monitors 200 that manage sound detection for a region of sound monitors 300ᵢ, such as an edge sound monitor for each floor in a multi-floor building, such as an office building or tower, or for different sections of a large space, such as a warehouse or complex of different buildings. For instance, there may be edge manager sound monitors 200 managing a subset of the satellite sound monitors 300ᵢ in each section of a large building or space that isolates sound into different areas.

In described embodiments, the components of FIG. 1 are described as being wirelessly connected. In alternative embodiments some or all of the components in FIG. 1, including the manager sound monitor 200, sound monitors 300ᵢ, and devices 102ᵢ, may be connected via a wired connection of wires or cables.

Generally, program modules, such as the program components 104ᵢ, 208, 210, 212, and 308, among others, may comprise routines, programs, objects, components, logic, data structures, and so on that perform particular tasks or implement particular abstract data types.

The program components programs 104ᵢ, 208, 210, 212, and 308, among others, may comprise program code loaded into memory and executed by a processor. Alternatively, some or all of the program logic of these components may be implemented in hardware devices, such as in Application Specific Integrated Circuits (ASICs), Field Programmable Gate Arrays (FPGAs), etc.

The functions described as performed by the program components 104ᵢ, 208, 210, 212, and 308, among others, may be implemented as program code or hardware logic in fewer program modules than shown or implemented throughout a greater number of program modules than shown.

Certain of the program components, such as the sound tracking service 212, among others, may comprise a machine learning model classifier trained to output a next sound monitor 300_{N} likely to detect a noise from input comprising a source sound monitor 300_{S} that detected the noise. The training may use machine learning and deep learning algorithms, such as decision tree learning, association rule learning, neural network, inductive programming logic, support vector machines, Bayesian network, etc. For artificial neural network program implementations, the neural network may be trained using backward propagation to adjust weights and biases at nodes in a hidden layer to produce their output based on the received inputs. In backward propagation used to train a neural network machine learning module, biases at nodes in the hidden layer are adjusted accordingly to produce the output having specified confidence levels based on the input parameters. The machine learning model 212 may be trained to produce output based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error. Other techniques may be used to train the sound tracking service 212 to adjust the biases and weights to minimize error between ground truth, comprising a labeled next sound monitor, and results from the machine learning model 212.

In an alternative embodiment, the sound tracking service 212 may be implemented not as a machine learning model but implemented using a rules-based system to determine the outputs from the inputs.

Components implemented as a machine learning model may be implemented in programs in memory or in a hardware accelerator or an inference engine.

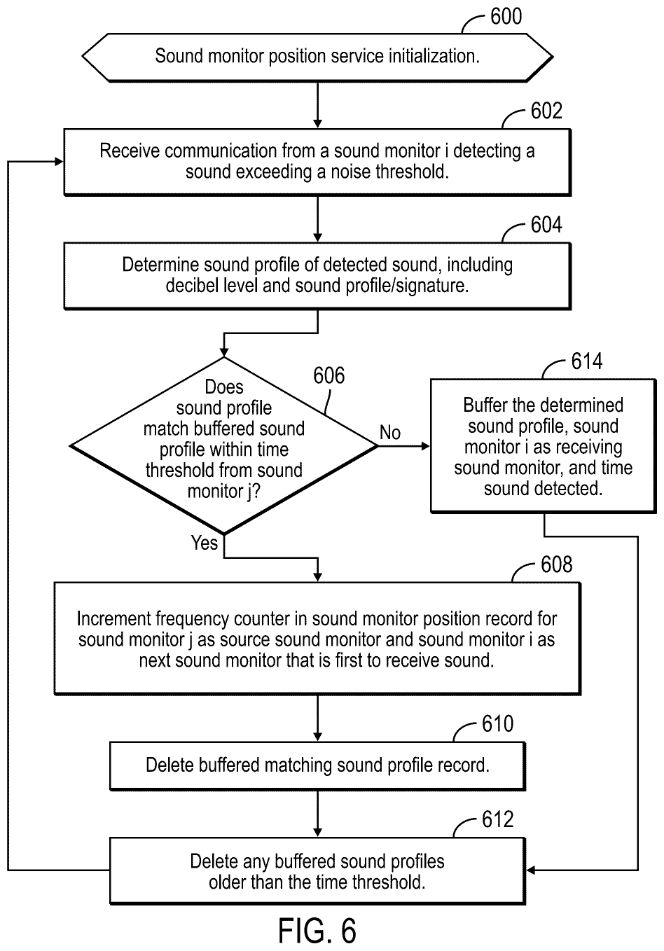

FIG. 6 illustrates an embodiment of operations performed by the sound monitor position service 208 to build the sound monitor position information 400 to use to determine a next sound monitor 300_{N} to which sound will travel from a source sound monitor 300_{S}. Upon initializing (at block 600) the sound monitor position service 208, the manager sound monitor 200 receives (at block 602) a communication from a sound monitor 300ᵢ detecting a sound exceeding a noise threshold. The sound monitor position service 208 determines (at block 604) a sound profile of the detected sound, including a decibel level and sound profile/signature identifying the shape of the sound. If (at block 606) the sound profile matches a buffered sound profile received at a previous source sound monitor 300ⱼ within a time threshold from the time the detected sound was received, then the sound monitor position service 208 increments (at block 608) a frequency counter 406 in the sound monitor position record 400ᵢ for sound monitor 300ⱼ as the source sound monitor 402 and sound monitor 300ᵢ as the next sound monitor 404 that is first to receive sound from the source sound monitor 402. The buffered matching sound profile record is deleted (at block 610) because the next sound monitor was located. The sound monitor position service 208 may further delete (at block 612) any buffered source profiles older than the time threshold that have not been matched with a next sound monitor.

If (at block 606) the sound profile does not match a buffered sound profile, then this is the first time the sound profile has been recently received, and the determined sound profile, sound monitor 300ᵢ, and the time the sound was detected is buffered (at block 614) and control proceeds to block 612. From block 612, control returns to process further received communications from sound monitors 300ᵢ to process.

With the embodiment of FIG. 6, the sound monitor position service 208 builds the sound monitor position information 400 to provide predictive information on a next sound monitor to detect a sound after it is detected at a source sound monitor to determine the area of the location most likely to be next affected by a disrupting noise so that user devices may take corrective action, such as mute a microphone.

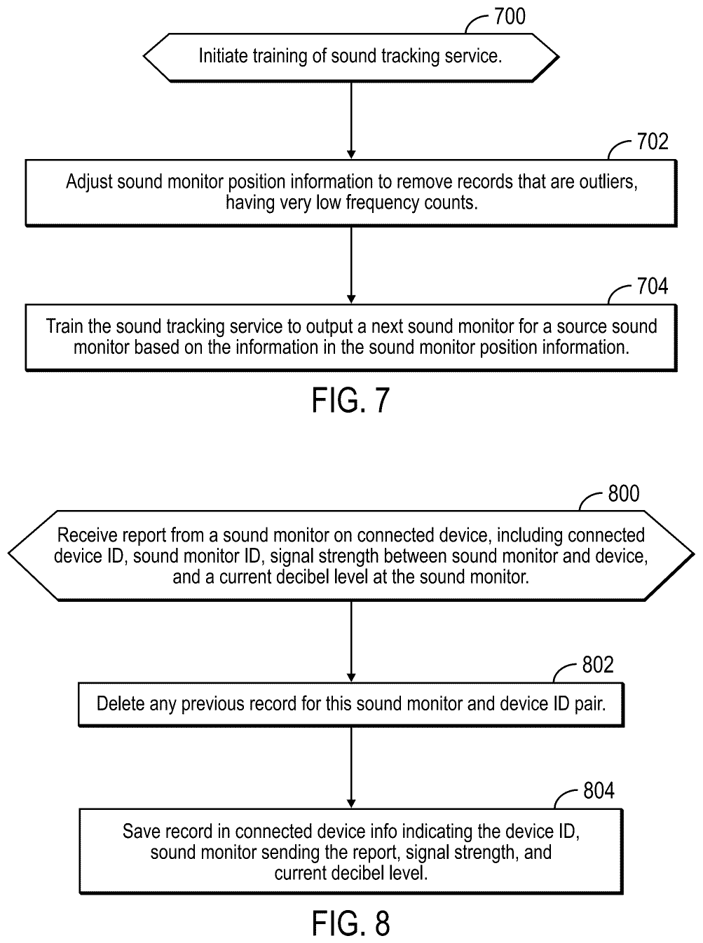

FIG. 7 illustrates an embodiment of operations to train the sound tracking service 212 to predict a next sound monitor from the gathered sound monitor position information 400, gathered according to FIG. 6. Upon initiating (at block 700) training of the sound tracking service 212, the sound monitor position information 400 is adjusted (at block 702) to remove records that are outliers, having very low frequency counts 406. The sound tracking service 212 is then trained (at block 704) to output a next sound monitor 300_{N} likely to detect a sound after the sound is detected at the source sound monitor 300_{S}. In embodiments where the sound tracking service 212 comprises a machine learning model, it may be trained using backpropagation to adjust the biases and weights to minimize error between ground truth results, comprising a labeled next sound monitor, and actual results from the machine learning model 212.

With the embodiment of FIG. 7, the sound tracking service 212 is trained to classify information on a source sound monitor 300_{S} to determine the next sound monitor 300_{N} likely to receive that sound next.

FIG. 8 illustrates an embodiment of operations performed by the connected device service 210 to gather connected device information 500. The manager sound monitor 200 receives (at block 800), from a reporting service 308 at a sound monitor 300ᵢ, a report on a connected device 102ᵢ, including connected device ID 502, sound monitor ID 504, signal strength between sound monitor 504 and device 502, and a current decibel level 508 at the sound monitor. Any previous record 500ᵢ for this sound monitor 504 and device ID 502 pair is deleted (at block 802) and a new record 500ⱼ is saved (at block 804) in the connected device information 500 with the received information 502, 504, 506, and 508.

With the embodiment of FIG. 8, the connected device information 500 includes the most recent gathered information for each device ID and sound monitor pair because the signal strength and decibel level at the sound monitor comprises dynamic information.

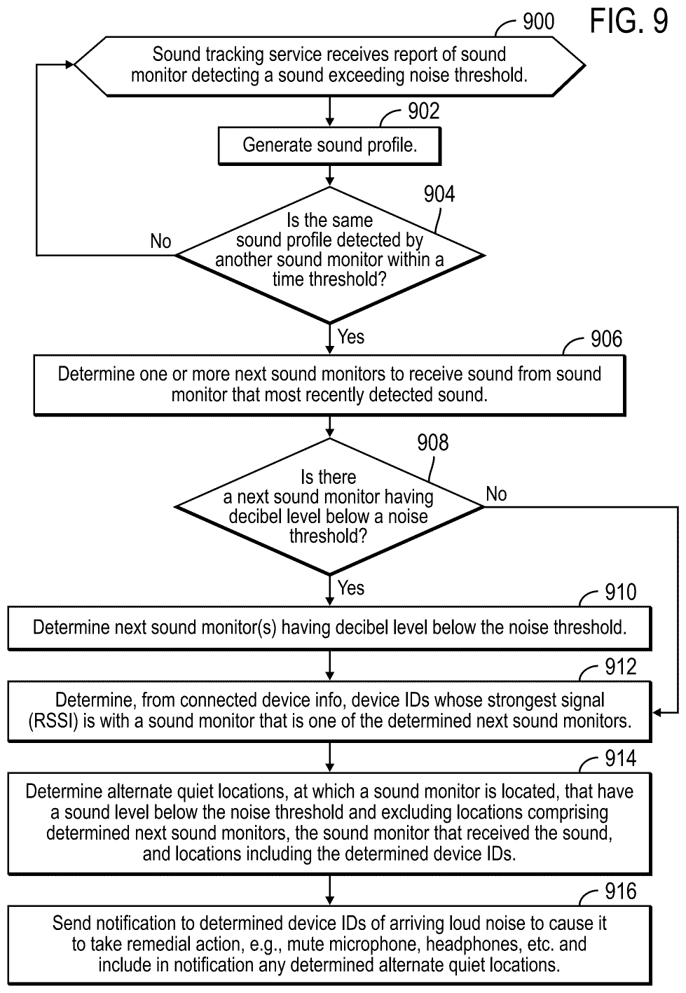

FIG. 9 illustrates an embodiment of operations performed by the sound tracking service 212 to track a sound detected at a sound monitor 300ᵢ. Upon the sound tracking service 212 receiving (at block 900) a report from a sound monitor 300ᵢ detecting a sound exceeding a sound threshold, such as threshold number of decibels, the sound tracking service 212 generates (at block 902) a sound profile, which may include the decibels of the detected sound and a profile or signature indicating the shape of the sound. If (at block 904) the same sound profile was detected by another sound monitor 300j within a time threshold, then the sound tracking service 212 determines (at block 906), as trained from sound monitor position information 400, one or more next sound monitors 404 in one or more sound monitor position records 400ᵢ indicating the detecting sound monitor 300ᵢ as the source sound monitor 402. If (at block 908) there is a next sound monitor 404 having a decibel level 508 below a noise threshold, indicating the next sound monitor 404 is in a quiet location, then the sound tracking service 212 determines (at block 910) that one or more next sound monitors 404 with a decibel level 508 below the noise threshold.

The sound tracking service 212 determines (at block 912), from the connected device information 500, device IDs 502, in connected device records 500ᵢ, whose strongest signal strength 506 is with a sound monitor 504 that is one of the determined next sound monitors 404. The sound tracking service 212 may further determine alternate quiet locations to which the operator of the device 502 may relocate to avoid the incoming sound. The sound tracking service 212 may determine alternate quiet locations, at which a sound monitor 300ᵢ is located, that have a sound level below the noise threshold and excluding locations comprising determined next sound monitors, the sound monitor that received the sound, and locations including the determined device IDs. The sound tracking service 212 sends (at block 914) a notification to the determined device IDs 502 that a loud noise will soon be arriving and sends notification of any determined alternate quiet locations. This notification causes the notification handler 104ᵢ at the receiving device 102ᵢ to take action, such as mute the microphone at the receiving device 102ᵢ, etc. Notification of quiet locations may motivate the operator of the device IDs 502 to move to one of the indicated quiet locations to avoid repeated instances of this sound.

If (at block 908) there is no next sound monitor having a decibel level below the noise threshold, then the sound tracking service 212 may proceed to block 912 et seq. to send notifications to devices having a strongest signal with respect to next sound monitors 300_{N} that have ambient noise greater than a threshold, are not quiet environments.

With the embodiment of FIG. 9, the sound tracking service 212 looks for a next sound monitor in a quiet environment and then notifies devices having their strongest signal strength with that next sound monitor in order to alert such devices that a loud sound is coming. This allows the device 102ᵢ time to take evasive action to avoid the impact of the incoming sound, such as mute the microphone at the device, so that the incoming loud noise does not disrupt activity in which the device 102ᵢ is involved, which may be impacted by a loud background noise, such as participating in a video/phone conference. Other evasive actions the device 102ᵢ may take include pausing a recording if the device 102ᵢ is performing a recoding operation or mute speakers at the 102ᵢ to block the sound. Further, the operator of the device may use notification of alternative quiet locations to relocate the device to one of the alternative quiet locations. With described embodiments, the sound tracking service 212 is able to track a sound as it propagates through an environment and captured by different sound monitors 300ᵢ in order to notify the devices and operators of the devices of the incoming sound so they can take action to avoid the impact of a loud sound.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

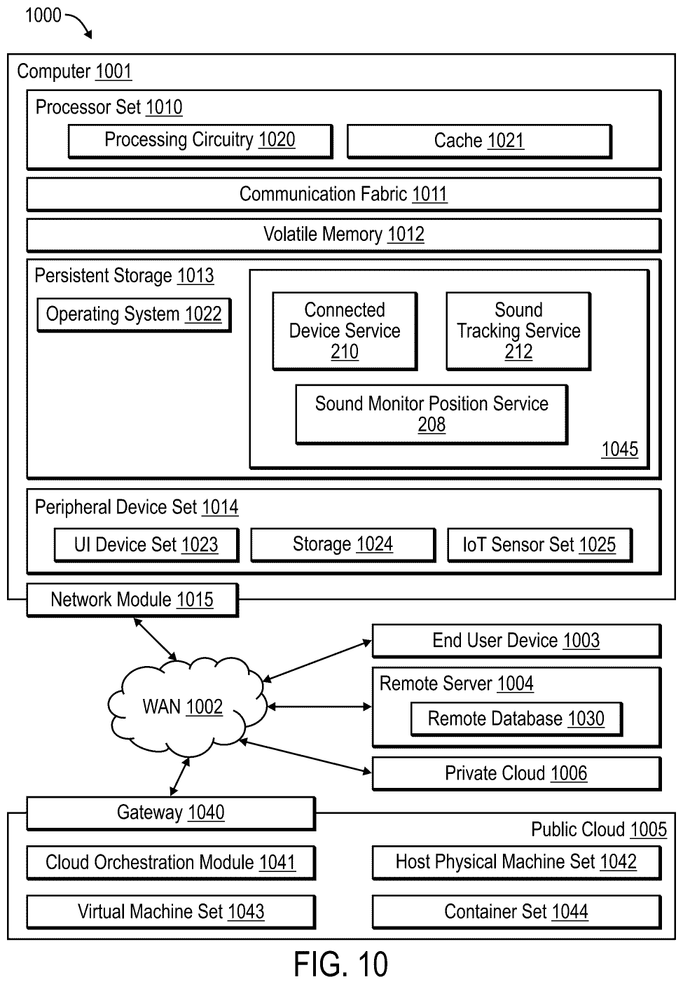

With respect to FIG. 10, computing environment 1000 contains an example of an environment for the execution of at least some of the computer code involved in performing the inventive methods, such as the components of the manager sound monitor 200, including the sound monitor position service 208, the connected device service 210, and the sound tracking service 212, among others in block 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on. The EUDs 1003 may include the sound monitors 300ᵢ and the devices 102ᵢ.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

CLOUD COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, j, n, N, S, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for generating notification in response to an incoming sound, wherein the computer program product comprises a computer readable storage medium having computer readable program code embodied therein that when executed performs operations, the operations comprising:
maintaining sound monitor position information on a plurality of sound monitors distributed at physical locations and connecting via a network, wherein the sound monitor position information indicates, for the sound monitors receiving sounds, next sound monitors to next receive the sounds received at the sound monitors;
detecting a sound at a receiving sound monitor comprising one of the sound monitors;
determining, from the sound monitor position information, a next sound monitor of the sound monitors to receive the sound after the receiving sound monitor;
determining a device connected to the next sound monitor; and
sending a notification to the device over the network that a sound is soon to arrive, wherein the notification causes the device to take mitigation to reduce impact of the sound at the device.

2. The computer program product of claim 1, wherein the operations further comprise:
determining whether the sound was received previously at a previous sound monitor of the sound monitors, wherein the determining the next sound monitor, the determining the device connected to the next sound monitor, and the sending the notification are performed in response to determining that the sound was received at the previous sound monitor.

3. The computer program product of claim 2, wherein the determining whether the sound was received previously at the previous sound monitor comprises:
determining whether the sound received at the receiving sound monitor has a sound profile matching the sound that was previously received at the previous sound monitor, wherein the determining that the sound was received at the previous sound monitor is made in response to determining that the sound received at the receiving sound monitor has the sound profile matching the sound that was previously received at the previous sound monitor.

4. The computer program product of claim 1, wherein the determining, from the sound monitor position information, the next sound monitor comprises:
determining, from the sound monitor position information, a plurality of next sound monitors to receive the sound received at the receiving sound monitor; and
determining one of the next sound monitors having a sound level less than a sound threshold, wherein the determining the device comprises determining the device connected to one of the next sound monitors having the sound level less than the sound threshold.

5. The computer program product of claim 4, wherein the operations further comprise:
in response to determining that none of the plurality of next sound monitors have a sound level less than the sound threshold, sending the notification to devices connected to the plurality of next sound monitors.

6. The computer program product of claim 1, wherein the determining the device connected to the next sound monitor comprises:
determining a device connected to the next sound monitor with a highest signal strength of signal strengths the device has with sound monitors.

7. The computer program product of claim 1, wherein the operations further comprise:
determining a quiet location having a decibel level, reported by one of the sound monitors, that below a sound threshold, wherein the notification indicates the quiet location.

8. The computer program product of claim 1, wherein the operations further comprise:
for each source sound monitor of the sound monitors detecting a sound, performing:
detecting a next sound monitor that is a first sound monitor to receive the sound after being detected by the source sound monitor; and
incrementing a counter in a record in the sound monitor position information indicating the next sound monitor as a next sound monitor of the source sound monitor, wherein the counter indicates a frequency the next sound monitor is detected as the first sound monitor to receive the sound after being detected by the source sound monitor.

9. The computer program product of claim 8, wherein the operations further comprise:
training a sound tracking service from records in the sound monitor position information to determine a next sound monitor for a sound monitor in the network receiving a sound, wherein the sound tracking service performs the determining, from the sound monitor position information, the next sound monitor to receive the sound after the receiving sound monitor.

10. A system for generating notification in response to an incoming sound, comprising:
a processor; and
a computer readable storage medium having computer readable program code embodied therein that when executed by the processor performs operations, the operations comprising:
maintaining sound monitor position information on a plurality of sound monitors distributed at physical locations and connecting via a network, wherein the sound monitor position information indicates, for the sound monitors receiving sounds, next sound monitors to next receive the sounds received at the sound monitors;
detecting a sound at a receiving sound monitor comprising one of the sound monitors;
determining, from the sound monitor position information, a next sound monitor of the sound monitors to receive the sound after the receiving sound monitor;
determining a device connected to the next sound monitor; and
sending a notification to the device over the network that a sound is soon to arrive, wherein the notification causes the device to take mitigation to reduce impact of the sound at the device.

11. The system of claim 10, wherein the operations further comprise:
determining whether the sound was received previously at a previous sound monitor of the sound monitors, wherein the determining the next sound monitor, the determining the device connected to the next sound monitor, and the sending the notification are performed in response to determining that the sound was received at the previous sound monitor.

12. The system of claim 10, wherein the determining, from the sound monitor position information, the next sound monitor comprises:
determining, from the sound monitor position information, a plurality of next sound monitors to receive the sound received at the receiving sound monitor; and
determining one of the next sound monitors having a sound level less than a sound threshold, wherein the determining the device comprises determining the device connected to one of the next sound monitors having the sound level less than the sound threshold.

13. The system of claim 10, wherein the operations further comprise:
determining a quiet location having a decibel level, reported by one of the sound monitors, that below a sound threshold, wherein the notification indicates the quiet location.

14. The system of claim 10, wherein the operations further comprise:
for each source sound monitor of the sound monitors detecting a sound, performing:
detecting a next sound monitor that is a first sound monitor to receive the sound after being detected by the source sound monitor; and
incrementing a counter in a record in the sound monitor position information indicating the next sound monitor as a next sound monitor of the source sound monitor, wherein the counter indicates a frequency the next sound monitor is detected as the first sound monitor to receive the sound after being detected by the source sound monitor.

15. The system of claim 14, wherein the operations further comprise:
training a sound tracking service from records in the sound monitor position information to determine a next sound monitor for a sound monitor in the network receiving a sound, wherein the sound tracking service performs the determining, from the sound monitor position information, the next sound monitor to receive the sound after the receiving sound monitor.

16. A computer implemented method for generating notification in response to an incoming sound, comprising:
maintaining sound monitor position information on a plurality of sound monitors distributed at physical locations and connecting via a network, wherein the sound monitor position information indicates, for the sound monitors receiving sounds, next sound monitors to next receive the sounds received at the sound monitors;
detecting a sound at a receiving sound monitor comprising one of the sound monitors;
determining, from the sound monitor position information, a next sound monitor of the sound monitors to receive the sound after the receiving sound monitor;
determining a device connected to the next sound monitor; and
sending a notification to the device over the network that a sound is soon to arrive, wherein the notification causes the device to take mitigation to reduce impact of the sound at the device.

17. The method of claim 16, further comprising:
determining whether the sound was received previously at a previous sound monitor of the sound monitors, wherein the determining the next sound monitor, the determining the device connected to the next sound monitor, and the sending the notification are performed in response to determining that the sound was received at the previous sound monitor.

18. The method of claim 16, wherein the determining, from the sound monitor position information, the next sound monitor comprises:
determining, from the sound monitor position information, a plurality of next sound monitors to receive the sound received at the receiving sound monitor; and
determining one of the next sound monitors having a sound level less than a sound threshold, wherein the determining the device comprises determining the device connected to one of the next sound monitors having the sound level less than the sound threshold.

19. The method of claim 16, further comprising:
for each source sound monitor of the sound monitors detecting a sound, performing:
detecting a next sound monitor that is a first sound monitor to receive the sound after being detected by the source sound monitor; and
incrementing a counter in a record in the sound monitor position information indicating the next sound monitor as a next sound monitor of the source sound monitor, wherein the counter indicates a frequency the next sound monitor is detected as the first sound monitor to receive the sound after being detected by the source sound monitor.

20. The method of claim 19, further comprising:
training a sound tracking service from records in the sound monitor position information to determine a next sound monitor for a sound monitor in the network receiving a sound, wherein the sound tracking service performs the determining, from the sound monitor position information, the next sound monitor to receive the sound after the receiving sound monitor.
